(19) United States
(12) Patent Application Publication
(10) Pub. No.: US 2010/0280859 A1
(43) Pub. Date: Nov. 4, 2010

(54) FUTURE CHECKS INTEGRATION

(75) Inventor: Carl R. Frederick, II, Newark, DE (US)

Correspondence Address: MOORE & VAN ALLEN, PLLC FOR BOFA, 430 DAVIS DRIVE, SUITE 500, POST OFFICE BOX 13706, RESEARCH TRIANGLE PARK, NC, 27709, US

(73) Assignee: BANK OF AMERICA CORPORATION, Charlotte, NC (US)

(21) Appl. No.: 12/433,619

(22) Filed: Apr. 30, 2009

(51) Int. Cl. G06Q 40/00; G06Q 10/00; G06K 9/00

(52) U.S. Cl. 705/7; 705/30; 705/35; 705/39; 382/137

(57) ABSTRACT

Embodiments of the present invention provide apparatuses and methods for a system that captures check data as the check is drafted or thereafter, and before the check is presented to the paying bank. Generally, a customer will use a data capture device to capture future check data from a check as the customer drafts the check. The future check data captured includes information drafted, printed, encoded, etc. on the check. Generally, the data capture device is a device, such as a digital pen, a scanner, a camera device, a device included in a customer's personal display assistant (“PDA”), or other data capture system. After the customer captures the future check data, the data is compared to the customer's account information at a financial institution. Alerts are sent to the customer if the customer is in danger of over drafting the account or if potential fraud is detected.

### FIELD

This invention relates generally to the field of check imaging, processing, and data collection, and more particularly embodiments of the invention relate to apparatuses and methods for capturing images and data before the check is presented to the paying bank for check processing, account inquires, and fraud detection purposes.

### BACKGROUND

As known, checks are negotiable instruments drawn against deposited funds that order a bank to pay a specified amount of money to a specified person on demand. Check collection, or “check clearing,” facilitates payment by moving checks from the banks where the checks are deposited (“receiving banks”) to the banks on whose accounts the checks are drawn (“paying banks”), and then moving the payment in the opposite direction. This credits accounts at the receiving bank and debits accounts at the paying bank.

The passing of the Check Clearing for the 21^{st} Century Act (“Check 21”) by Congress allowed recipients of paper checks to create a digital version of the paper check called an Image Replacement Document (“IRD”). Under Check 21, IRDs, officially named “Substitute Checks,” became a legal substitute for original paper checks. The IRDs include front and back images of the original checks, together with other data presented by a magnetic ink character recognition (“MICR”) line along the bottom of the checks, where such other data typically includes the routing and transit number, the check-writer's account number, and/or the dollar amount of the check.

Businesses and banks can work strictly with IRDs, transfer paper copies to IRDs, or in some cases use paper copies of the IRDs when exchanging the files between member banks, savings and loans, credit unions, services, clearinghouses, and the Federal Reserve Bank (“Fed”). Additionally, a process known as “remote deposit” allows customers to upload the digital images of checks to the depositing institution directly, in order to get their account credited. This is accomplished through electronic deposit of checks through an Automated Teller Machine (“ATM”), a process known as an electronic funds transfer (“EFT”). Some banks don't have the ability to create or process digital images. In such cases, third-party companies offer image processing services to these banks. The advent of Check 21 has greatly reduced check processing costs for banks, while speeding up fund transfers and reducing float time. Furthermore, due in part to Check 21, banks have the ability to handle various forms of electronic data and images related to checks and check processing.

Generally, paper checks are printed and sent to customers from several check printing firms, for use in various transactions. Customers write on the checks, and then send them out to various institutions or people as payment for goods and services. When checks are written today, customers must manually update their own records to determine if they are about to withdraw excess funds, which could result in over-drafting the customers' accounts. Alternatively, some customers, such as businesses, use software to print their checks, and thus have an electronic record of the amount and approximate date of payment. In the case of customers who print their checks, these customers may have the ability, through software, to keep track of checks made on their behalf electronically.

Customers sometimes skip checking their accounts before writing or presenting a check for payment. They may also forget to update their own records after presenting a check. The customer may view these steps in the process of offering payment through a check as a nuisance. Even if one account holder regularly monitors their account, joint and multiple account holders may have several activities affecting account balances at the same time. Therefore, a customer unaware of the activities of the joint account holders may not have a good idea of the available balance in the customer's account at the time of drafting a check for payment. Additionally, customers may possibly forget to write or mail their checks from time to time, such as when a bill is misplaced, which may result in late fees.

Furthermore, generally, check fraud is achieved by intercepting a batch of valid blank checks and forging the customer's signature, printing another customer's account number on a false check, or altering checks that the customer has submitted for payment, to name a few techniques. These situations are not easily detected until it is too late and the customer has already lost funds due to check fraud.

Furthermore, financial institutions today only learn about transactions involving customers' checks when the checks are received and processed, which is often done through the use of software systems compliant with regulations under Check 21 for handling digital or paper check images. On the other hand, customers are only made aware of posted checks they have offered for payment when making an inquiry into their account status and discovering that the funds are debited from their accounts.

There is a need to develop apparatuses and methods to process checks, before they are presented as payment, in a way that notifies customers and financial institutions that a transaction is going to be made in the future that will impact the balance of the customers' accounts.

### BRIEF SUMMARY

Embodiments of the present invention address the above needs and/or achieve other advantages by providing apparatuses (e.g., a system, computer program product, and/or other device), methods, or a combination of the foregoing for a system that captures check data as the check is drafted or thereafter, and before the check is offered for payment by the customer or before the check is presented to the paying bank.

Generally, in one embodiment of the invention, a customer will use a data capture device to capture future check data from a check as the customer drafts the check. The future check data captured includes, but is not limited to, the payee, the amount, the date, the customer's account, the routing/transit number, the customer's signature, the check number, etc. The data capture device, in some embodiments, is for example a device, such as a digital pen, a scanner, a camera device, a device included in a customer's personal display assistant (“PDA”), or other data capture system.

After the customer captures the future check data, in one embodiment, the future check data is sent to the customer's financial institution. The data is compared to the customer's account balance, and messages are sent to the customer, alerting the customer that the check will, may, or will not overdraft the customer's account based on other future check data for other transactions, recurring transactions set up by the customer, or checks which have recently posted. Furthermore, in some embodiments alerts are set up to notify the customer when checks are presented to the bank for payment which do not have corresponding future check data sent by the customer, thus indicating potential fraudulent activity.

One embodiment of the invention is a future check integration system comprising, a data capture device, a memory device, a communication device, and a processing device. The processing device is operatively coupled to the data capture device, the memory device, and the communication device. The processing device is configured to execute computer-readable program code to capture data related to a check, before the check is presented to the paying bank, using the data capture device. The processing device is also configured to execute computer-readable program code to store the captured data related to the check on the memory device. The processing device is further configured to execute computer-readable program code to receive account information from a financial institution or affiliate, using the communication device that is configured to communicate with a device at the financial institution or affiliate.

In further accord with an embodiment of the invention, the data capture device comprises a digital pen configured to capture information written on the check.

In another embodiment of the invention, the data capture device comprises a digital device with a camera for capturing an image of the check.

In yet another embodiment of the invention, the data capture device comprises a device with a touch screen or touch pad configured to capture information written on the check.

In another embodiment of the invention, the data capture device comprises a reader configured to capture machine-readable information located on the check.

In yet another embodiment of the invention, the processing device is configured to execute computer-readable program code to communicate the captured data related to the check to the financial institution or affiliate. The communication is done using the communication device that is configured to communicate with a device at the financial institution or affiliate. The financial institution or affiliate compares the captured data related to the check with a customer's account information.

In further accord with an embodiment of the invention, the processing device is configured to execute computer-readable program code to receive account information from the financial institution or affiliate. The account information is received using the communication device that is configured to communicate with a device at the financial institution or affiliate. The account information comprises at least partially a comparison of the captured data related to the check with a customer's account transactions.

In another embodiment of the invention, the processing device is configured to execute computer-readable program code to receive account information from the financial institution or affiliate. The account information is received using the communication device that is configured to communicate with a device at the financial institution or affiliate. The account information comprises at least partially alerts related to the check, such as the check is within the available funds, an overdraft will occur, or an overdraft might occur.

In yet another embodiment of the invention, the processing device is configured to execute computer-readable program code to receive account information from the financial institution or affiliate. The account information is received using the communication device that is configured to communicate with a device at the financial institution or affiliate, wherein the account information comprises at least partially alerts related to the check that potential fraud has occurred with a customer's account.

One embodiment of the invention is a future check integration system comprising a data capture device, a memory device, a communication device, and a processing device. The processing device is operatively coupled to the data capture device, the memory device, and the communication device. The processing device is configured to execute computer-readable program code to capture data related to a check, before the check is presented to the paying bank, using the data capture device. The processing device is also configured to execute computer-readable program code to store the captured data related to the check on the memory device. The processing device is further configured to execute computer-readable program code to communicate the captured data related to the check to at least one other device, using the communication device that is configured to communicate with the at least one other device.

In further accord with an embodiment of the invention, the at least one other device comprises a device in a customer computer system that is configured to receive the captured data related to the check. The customer computer system is also configured to receive account information from a financial institution or affiliate, and to compare the captured data related to the check to the account information.

In another embodiment of the invention, the at least one other device comprises a device in a bank computer system that is configured to receive the captured data related to the check. The bank computer system is also configured to compare the captured data related to the check to account information.

In yet another embodiment of the invention, the processing device is configured to execute computer readable-program code to receive account information from a financial institution or affiliate, using the communication device that is configured to communicate with a device at the financial institution or affiliate. The account information comprises at least partially a comparison of the captured data related to the check with a customer's account transactions or at least partially alerts related to the check, such as the check is within the available funds, an overdraft will occur, an overdraft might occur, or potential fraud has occurred with a customer's account.

In another embodiment of the invention, the data capture device comprises a digital pen configured to capture information written on the check.

In yet another embodiment of the invention, the data capture device comprises a digital device with a camera for capturing an image of the check.

In another embodiment of the invention, the data capture device comprises a device with a touch screen or touch pad configured to capture information written on the check.

In yet another embodiment of the invention, the data capture device comprises a reader configured to capture machine-readable information located on the check.

One embodiment of the invention is a future checks integration system comprising a memory device, a communication device, and a processing device. The processing device is operatively coupled to the data capture device, the memory device, and the communication device. The processing device is configured to execute computer-readable program code to receive data related to a check, before the check is presented to a paying bank. The data related to a check is received using the communication device that is configured to communicate with a device in a customer computer system or a data capture system. The processing device is also configured to execute computer-readable program code to store the captured data related to the check on the memory device. The processing device is further configured to execute computer-readable program code to compare the captured data related to the check with a customer's account information.

In another embodiment of the invention, the processing device is configured to execute computer-readable program code to communicate an application to a data capture system or a customer computer system, wherein the application provides the user with the capability of capturing check data or receiving account information.

In yet another embodiment of the invention, the processing device is configured to execute computer-readable program code to communicate alerts related to the check to the customer computer system, such as the check is within the available funds, an overdraft will occur, or an overdraft might occur.

In another embodiment of the invention, the processing device is configured to execute computer-readable program code to communicate alerts related to the check to the customer computer system that potential fraud has occurred with a customer's account.

In yet another embodiment of the invention, the processing device is configured to execute computer-readable program code to receive actions from the customer computer system to transfer funds, stop payment on the check, change a date of payment for the check, or change alerts set up by a customer.

One embodiment of the invention is a computer program product for a future check integration system, the computer program product comprises at least one computer-readable medium having computer-readable program code portions embodied therein. The computer-readable program code portions comprise an executable portion configured for capturing data related to a check, before the check is presented to a paying bank, using a data capture device and a processing device. The processing device is operatively coupled to the data capture device, a memory device, and a communication device, and is configured to execute computer-readable program code. The computer-readable program code portions also comprise an executable portion configured for storing the captured data related to the check on a memory device. The computer-readable program code portions further comprise an executable portion configured for communicating the data related to the check to at least one other device using the communication device that is configured to communicate with the at least one other device.

In another embodiment of the invention, data capture device comprises at least one of a digital pen configured to capture information written on the check, a digital device with a camera configured to capture an image of the check, a device with a touch screen or touch pad configured to capture information written on the check, or a reader configured to capture machine-readable information located on the check.

In yet another embodiment of the invention, the at least one other device comprises a device in a customer computer system that is configured to receive the captured data related to the check. The customer computer system is also configured to receive account information from a financial institution or affiliate, and to compare the captured data related to the check to the account information.

In another embodiment of the invention, the at least one other device comprises a device in a bank computer system that is configured for comparing the captured data related to the check with account information from a financial institution or affiliate.

In yet another embodiment of the invention, the computer program product further comprises an executable portion configured to receive account information from a financial institution or affiliate using the communication device that is configured to communicate with a device at a financial institution or affiliate. The account information comprises at least partially a comparison of the captured data related to the check with a customer's account transactions, or at least partially alerts related to the check that it is within the funds in the account, will cause an overdraft in the account, could cause an overdraft in the account, or potential fraud has occurred with the customer account.

One embodiment of the invention is a computer program product for a future check integration system, the computer program product comprises at least one computer-readable medium having computer-readable program code portions embodied therein. The computer-readable program code portions comprise an executable portion configured for receiving from a customer computer system or a data capture system, data related to a check, before the check is presented to the paying bank. The data related to check is received using a communication device and a processing device that is operatively coupled to the communication device and a memory device, and configured to execute computer-readable program code. The computer-readable program code portions also comprise an executable portion configured for storing the captured data related to the check on the memory device. The computer-readable program code portions further comprise an executable portion configured for comparing the captured data related to the check with a customer's account information.

In another embodiment of the invention, the computer program product comprises an executable portion configured for communicating an application to the data capture system or the customer computer system. The application is communicated using a communication device configured to communicate with the customer computer system or the data capture system. The application provides the user with the capability of capturing the data related to the check or receiving the customer's account information.

In yet another embodiment of the invention, the computer program product comprises an executable portion configured for communicating alerts related to the check to the customer computer system or the data capture system, such as the check is within the available funds, an overdraft will occur, or an overdraft might occur. The alerts are communicated using a communication device configured to communicate with the customer computer system or the data capture system.

In another embodiment of the invention, the computer program product comprises an executable portion configured for communicating alerts related to the check to the customer computer system or the data capture system that potential fraud has occurred with a customer's account. The alerts are communicated using a communication device configured to communicate with the customer computer system or the data capture system.

In yet another embodiment of the invention, the computer program product comprises an executable portion configured for receiving account actions from the customer computer system or the data capture system to transfer funds, stop payment on the check, change the date of payment for the check, or change the alerts set up by a customer. The account actions are received using a communication device configured to communicate with the customer computer system or data capture system.

One embodiment of the invention is a future check integration method comprising capturing data related to a check, before the check is presented to the paying bank. The data related to a check is captured using a data capture device and a processing device operatively coupled to the data capture device, a memory device, and a communication device, and configured to execute computer-readable program code. The method also comprises storing the captured data related to the check on the memory device. The method further comprises communicating data related to the check using a communication device configured to communicate with at least one other device.

In further accord with an embodiment of the invention, the data capture device comprises at least one of a digital pen configured to capture information written on the check, a digital device with a camera configured to capture an image of the check, a device with a touch screen or touch pad configured to capture information written on the check, or a reader configured to capture machine-readable information located on the check.

In another embodiment of the invention, the at least one other device comprises a device in a customer computer system that is configured for receiving the captured data related to the check. The customer computer system is also configured to receive account information from a financial institution or affiliate, and to compare the captured data related to the check to the account information.

In yet another embodiment of the invention, the at least one other device is a device in a bank computer system that is configured for comparing the captured data related to the check with account information from a financial institution or affiliate.

In another embodiment of the invention, the processing device is configured to execute computer readable-program code for receiving a customer's account information from a financial institution or affiliate to compare the data related to the check to a customer's account information. The customer's account information is received using a communication device configured to communicate with the financial institution or affiliate.

In yet another embodiment of the invention, the processing device is configured to execute computer readable-program code for receiving account information from a financial institution or affiliate. The account information is received using the communication device that is configured to communicate with a device at the financial institution or affiliate. The account information comprises at least partially a comparison of the captured data related to the check with a customer's account transactions, or at least partially alerts related to the check, such as the check is within the available funds, an overdraft will occur, an overdraft might occur, or potential fraud has occurred with a customer's account.

One embodiment of the invention is a future check integration method comprising receiving from a customer computer system or data capture system data related to a check, before the check is presented to the paying bank. The data related to the check is received using a communication device and a processing device that is operatively coupled to the communication device and a memory device, and configured to execute computer-readable program code. The method also comprises storing the captured data related to the check on the memory device. The method further comprises comparing the captured data related to the check with a customer's account information.

In further accord with an embodiment of the invention, the future check integration method comprises communicating an application to the data capture system or the customer computer system. The application is communicated using a communication device configured to communicate with the customer computer system or the data capture system. The application provides the user with the capability of capturing the data related to the check or receiving the customer's account information.

In another embodiment of the invention, the future check integration method comprises communicating alerts related to the check to the customer computer system or the data capture system, such as the check is within the available funds, an overdraft will occur, or an overdraft might occur. The alerts are communicated using a communication device configured to communicate with the customer computer system or the data capture system.

In yet another embodiment of the invention, the future check integration method comprises communicating alerts related to the check to the customer computer system or the data capture systems, such as potential fraud has occurred with a customer's account. The alerts are communicated using a communication device configured to communicate with the customer computer system or the data capture system.

In another embodiment of the invention, the future check integration method comprises receiving account actions from the customer computer system or the data capture system to transfer funds, stop payment on the check, change the date of payment for the check, or change alerts set up by a customer.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 provides a block diagram illustrating a future check system, in accordance with an embodiment of the present invention;

FIG. 2 provides a process flow illustrating how future check data is processed through an intermediary personal computing device, in accordance with one embodiment of the present invention;

FIG. 3 provides a process flow illustrating how future check data is processed wirelessly and sent to a financial institution, in accordance with one embodiment of the present invention;

FIG. 4 provides a process flow illustrating how future check data may be analyzed before or after being sent to a financial institution, in accordance with one embodiment of the invention;

FIG. 5 provides a process map illustrating how future check data is used in comparison to other transactions, in accordance with an embodiment of the present invention; and

FIG. 6 provides a process map illustrating how future check data and non-check transactions are used to trigger customer alerts, in accordance with an embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “bank,” one of ordinary skill in the art will appreciate that other embodiments of the invention may involve other businesses or financial institutions that take the place of or work in conjunction with the bank to perform one or more of the processes or steps described herein as being performed by a bank.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

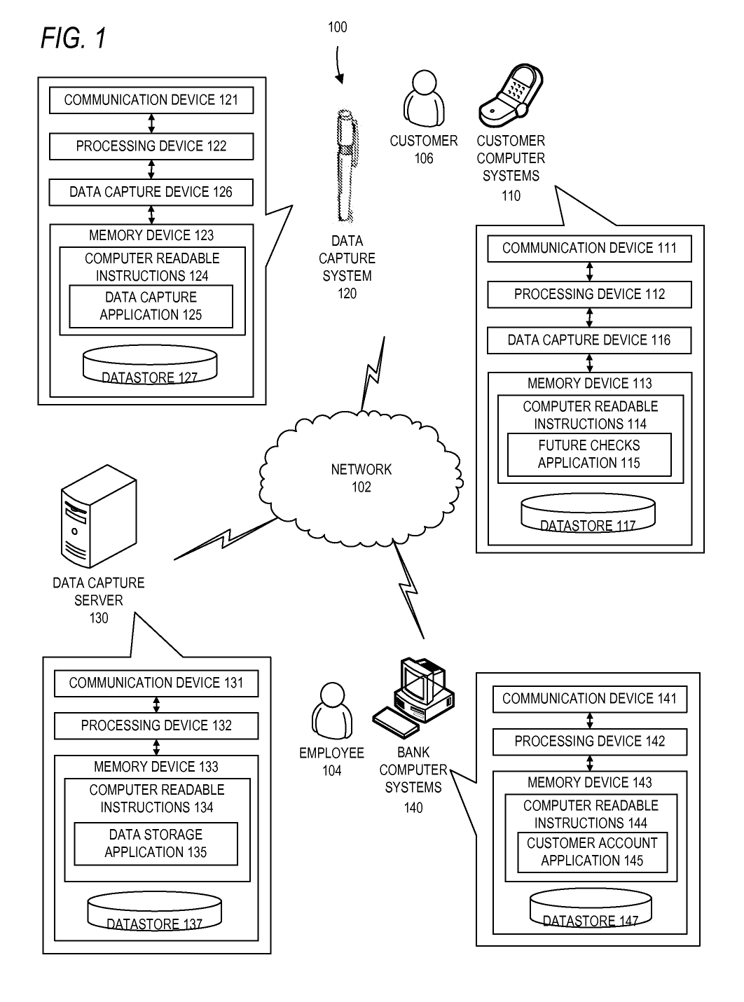

FIG. 1 illustrates a future check integration system 100 in accordance with an embodiment of the present invention. As illustrated in FIG. 1, the customer computer systems 110 are operatively coupled, via a network 102, to the data capture system 120, data capture server 130, and the bank computer systems 140. In this way, the customer 106 can receive and send electronic check data, including images and other related data, to and from these systems. The network 102 may be a global area network (GAN), such as the Internet, a wide area network (WAN), a local area network (LAN), or any other type of network or combination of networks. The network 102 may provide for wireline, wireless, or a combination of wireline and wireless communication between devices in the network.

As illustrated in FIG. 1, the customer computer systems 110 may be a single system or a combination of systems including but not limited to a general computer system, personal display device, such as a PDA, laptop, phone, camera phone, or other type of system used to access other systems over a network. Furthermore, the customer computer systems 110 may include aspects of one or more data capture systems 120, such as a digital pen, data pen, a camera, touch screen, touch pad, or other data capture device used to capture data on site as the information is being created or thereafter.

The customer computer systems 110 generally include a communication device 111, a processing device 112, a memory device 113, and a data capture device 116. As used herein, the term “processing device” generally includes circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 112 is operatively coupled to the communication device 111, the memory device 113, and the data capture device 116. The processing device 112 uses the communication device 111 to communicate with the network 102, and other devices on the network 102, such as, but not limited to, one or more data capture systems 120, data capture servers 130, and/or the bank computer systems 140. As such, the communication device 111 generally comprises a modem, server, or other device for communicating with other devices on the network 102, and a display, mouse, keyboard, microphone, and/or speaker for communicating with one or more users, such as a customer 106. The data capture device 116 included in some embodiments of the customer computer systems 110 is a device that can capture information, such as a scanning device, image capture device, a device that captures movement of handwriting, a radio frequency transceiver, an inferred transceiver, a touch screen, touch pad, or other device or combination of devices that can capture data.

As further illustrated in FIG. 1, the customer computer systems 110 include computer-readable instructions 114 stored in the memory device 113, which in one embodiment include the computer-readable instructions 114 of a future checks application 115. As discussed later, in one embodiment, the future checks application 115 allows the customer 106 to receive data related to the future checks captured from the data capture system 120 and communicate with the customer account application 145 in the bank computer systems 140. In some embodiments, the memory device 113 includes a datastore 117 for storing data related to the customer computer systems 110, including but not limited to data created and/or used by the future checks application 115.

The data capture system 120, may be a system that can capture information as the information is created, or, in some embodiments, shortly thereafter, such as a digital pen, data pen, camera, touch screen, touch pad, digital check notebook, image scanner, barcode reader, radio frequency identification tag (“RFID”) reader, and/or other data capture system or combination of data capture systems used to capture data on site as the information is being created or thereafter. The data capture system 120 generally includes, in some embodiments, a communication device 121, a processing device 122, a memory device 123, and a data capture device 126. The processing device 122 is operatively coupled to the communication device 121, the memory device 123, and the data capture device 126.

The processing device 122 uses the communication device 121 to communicate with the network 102, and other devices on the network 102, such as, but not limited to, one or more customer computer systems 110, data capture servers 130, and/or bank computer systems 140. As such, the communication device 121 generally comprises a modem, server, or other device(s) for communicating with other devices on the network 102, and a display, mouse, keyboard, microphone, and/or speakers for communicating with one or more users. The data capture device 116, of the customer computer systems 110, may include a device that can capture information, such as a scanning device, image capture device, a device that captures movement of handwriting, a radio frequency transceiver, an inferred transceiver, a touch screen, touch pad, or other device or combination of devices that can capture data.

As further illustrated in FIG. 1, the data capture systems 120 contain computer-readable program instructions 124 stored in the memory device 123, which in one embodiment include the computer-readable instructions 124 of a data capture application 125. The data capture application 125, in one embodiment, is used to capture data related to checks before the checks are presented to the paying bank, and transmit that data to the customer computer systems 110, data capture servers 130, and/or bank computer systems 140, as discussed later. In some embodiments, the memory device 123 includes a datastore 127 for storing data related to the data capture system 120, including but not limited to data created and/or used by the data capture application 125.

In one embodiment of the invention, the future check integration system 100 has multiple data capture systems 120 for capturing data related to checks for many customers. Although FIG. 1 illustrates the data capture system 120 as one system, it is important to note that there can be one or multiple systems, or the data capture system 120 can be incorporated into other systems, such as the customer computer systems 110.

The data capture server 130 generally includes a communication device 131, a processing device 132, and a memory device 133. The processing device 132 is operatively coupled to the communication device 131 and the memory device 133. The processing device 132 uses the communication device 131 to communicate with the network 102, and other devices on the network 102, such as, but not limited to, the customer computer systems 110, data capture systems 120, and/or bank computer systems 140. As such, the communication device 131 generally comprises a modem, server, or other device(s) for communicating with other devices on the network 102.

As further illustrated in FIG. 1, the data capture severs 130 contain computer-readable program instructions 134 stored in the memory device 133, which in one embodiment include the computer-readable instructions 134 of a data storage application 135. The data storage application 135 is used to store the data captured from checks as the checks are drafted or thereafter, and any associated data for the checks, in a secure location for access by the customers 106 and various bank employees 104 through the use of the customer computer systems 110, data capture systems 120, and/or bank computer systems 140, as well as possibly other systems. In some embodiments, the memory device 133 includes a datastore 137 for storing data related to the data capture server 130, including but not limited to data created and/or used by the data storage application 135.

The data capture severs 130, in some embodiments, are used to store data, such as the future check data. The data comes from the data capture system 120 and/or the customer computer systems 110, directly, or in some embodiments through the bank computer systems 140, along with data related to the customer's account.

As illustrated in FIG. 1, the bank computer systems 140 generally include a communication device 141, a processing device 142, and a memory device 143. The processing device 142 is operatively coupled to the communication device 141 and the memory device 143. The processing device 142 uses the communication device 141 to communicate with the network 102, and other devices on the network 102, such as, but not limited to, the customer computer systems 110, data capture systems 120, and/or data capture servers 130. As such, the communication device 141 generally comprises a modem, server, or other device for communicating with other devices on the network 102, and a display, mouse, keyboard, microphone, and/or speakers for communicating with one or more users, such as a bank employee 104.

As further illustrated in FIG. 1, the bank computer systems 140 include computer-readable instructions 144 stored in the memory device 143, which in one embodiment include the computer-readable instructions 144 for, but not limited to, customer account applications 145. The customer account applications 145 allow the employee 104 to make inquiries into and/or changes to the accounts of customers 106 based on the data captured from the customer's checks and associated data, as discussed later. In some embodiments, the memory device 143 includes a datastore 147 for storing data related to the bank computer systems 140, including but not limited to data created and/or used by the customer account application 145.

Although FIG. 1 illustrates the bank computer system 140 as one system, it is important to note that there can be one or multiple systems with one or multiple applications, each with similar components that handle a number of functions related to customer accounts or other systems at the bank.

The future checks system 100 automatically, or nearly automatically, captures information about customer 106 checks drafted, even before they are mailed, submitted for payment, or presented to the paying bank. The information captured includes, but is not limited to, the customer account number, routing/transit number, bank information, the amount of a check, the payee, customer signature information, customer address information, check number, memo, and/or optical, magnetic, and/or other data recognition markings and/or data tags on the check (also described as “future check data”). The information is then integrated into financial software, including but not limited to the future checks application 115 and customer account applications 145, to enable the customer 106 to proactively be advised as to how the future check will impact the customer's 106 account. For example, if a recent purchase puts a customer 106 at risk of withdrawing more funds from the customer's account than is available through the account, then because of the knowledge of future checks that have yet to be presented, the customer 106 can take the proper action before the customer's account is over-drawn. This enables customers 106 to take preemptive measures much sooner, by, for example, moving funds around or postponing sending a check for payment for a few days. In some embodiments, customers 106 are also notified of account alerts when using other forms of payment outside of a check, such as check cards or other forms of payment linked with the customer's account.

Embodiments of the invention are enabled by data capture systems 120, such as but not limited to, digital pens, devices with a touch screen or touch pad, devices with cameras, digital check notebooks, image scanners, and/or barcode, RFID, optical, magnetic, and/or other readers, and/or other devices that are able to identify information written or contained on the customer's checks, and then communicate the information so that the information can be integrated into computer software linked to the customer's account at a financial institution.

As an illustration, digital pens exist that are able to capture what is written on a page of a notebook, and automatically identify what is written on each page. One embodiment of the invention uses an adaptation of such digital pens to capture what is written on a check. In one such embodiment, everything the customer writes on the check using the digital pen is captured and then integrated into financial software. The ability to incorporate new applications into these digital pen platforms exists, since these platforms are enabled by software, already have the necessary features, and encourage a community of developers to develop new ideas. In some embodiments the digital pen can have an optical reader or other data reading device. The reader can be used to capture information on the check that is not written by the customer 106. For example, the reader can capture data from a bar code, or like data recognition markings or other machine-readable information on the check that provides information, such as the check number, account number, routing number, etc.

Today, generally, digital pens use wired technology to transmit data about what is written to software. This potentially could cause a delay in transferring the future check data to the financial institution until the customer 106 can dock the digital pen with a customer computer system 110. This potentially reduces the effectiveness of determining if the customer 106 has the proper funds for payment and potentially reduces the effectiveness of the check fraud prevention measures. However, there are digital devices, including digital pens, that use wireless technology to connect to networks like Wi-Fi devices, mobile devices, and/or telecommunication carriers' networks. With wireless capability, in some embodiments of the invention, checks written may be synced with the customer computer systems 110 and/or the bank computer systems 140. In such wireless embodiments, security issues of using wireless technology to transfer check data may be addressed by encrypted technology or other available security technology. Without having to dock the digital pen with a customer computer system 110 before transmitting it to a financial institution, the future check data can be sent to the financial institution from any location, in some embodiments of the invention.

Additionally, alternative devices with touch screens or touch pads that capture written information can be used to capture future check data. The approach of using touch pads or touch screens, like those available in mobile phones, can take a number of forms and is accomplished by placing them under checks before drafting the checks to capture any information written on the check. The devices may use flat touch screens, like those used in touch screen phones, or foldable screens that can function as a touch screen. For example, a customer drafting a check 106 can write the check with a conventional pen on a phone touch screen, such as the Apple iPhone or other touch screen phone, which will capture the information written on the check by the customer 106. Furthermore, a touch pad may have the ability to capture individual or biometric data related to how a customer drafts a check. For example, the touch pad, in some embodiments, can detect the pressure, speed, or the actual formation of the letters and numbers, of the customer's handwriting. This information may be used for fraud detection purposes. Still in other embodiments of the invention gesture-based technologies may be used to capture information related to how a customer drafts a check.

In other embodiments of the invention, a digital check notebook may be used to capture future check data. The digital check notebook can be a checkbook holder that doubles as a data capture system 120. The digital check notebook can have a touch screen that is used by the customer 106 when drafting a check. The digital check notebook can capture the data drafted on the check and transfer it to a customer computer system 110 or a bank computer system 140. Furthermore, as with the digital pen, these devices can have a scanner, reader, or like device that can capture information on the check that is not drafted by the customer 106.

In other embodiments, a device with a camera or scanner may be used to take a picture or image in order to capture information related to the check. For example, in one embodiment, after a customer 106 writes a check with a conventional pen, a picture or image is taken of the check. Computer software, such as the data capture application 125, can then determine the information on the check. Once the check information is digitally captured, the financial software then uses image processing algorithms, such as optical character recognition (“OCR”) technology to identify items such as, but not limited to the check number, the date written on the check, the check amount, to whom the check is written, and/or any other information on the check. Furthermore, the information captured can include the customer's signature for verification and fraud detection purposes.

The check image itself, in some embodiments, can be sent to the financial institutions and processed to create the future check data that is used to manage finances when coordinated with the customer's account information and future transactions (e.g. recurring electronic payments). Additionally, the future check data can be further analyzed against the presented check, when it is received by the bank, for any material and immaterial changes to the presented check for fraud detection purposes. The financial institutions and other firms already have technologies to process check images and pull data from the images, which in one embodiment they can apply to process future check data in advance of posting.

In other embodiments, a device with a camera or video can be utilized to capture images or video of the customer 106 as the customer 106 is drafting the check. This data can be used to capture the customer's handwriting pattern for check verification and fraud detection purposes. In other embodiments, a picture of the customer 106 is taken to associate the customer 106 with the customer's account and/or future check data using facial recognition software.

In some embodiments, the data capture system 120 is configured to capture some future check data automatically through the data capture device 126, but requires the user to manually enter other future check data. For example, in one embodiment, the data capture system 120 comprises an optical reader, barcode scanner, or other reader or scanner, a keypad or other data entry device, and a display device. The scanner or reader captures the future check data related to the barcode or other computer-readable data related to the customer's account, transit/routing number, and/or check number, but it may not be able to capture data written on the check. Therefore, in some embodiments, the customer 103 enters in information into the data capture system 120, such as the check amount, payee, date, etc., through for example the keypad or like device.

In some embodiments, the data capture system 120 is configured to capture the future check data manually. For example, in one embodiment, the data capture system comprises a keypad or other data entry device, and a display device. The customer 106 drafts a check, and then enters information related to the check manually through the keypad or other data entry device.

Alternatively, the customer computer systems 110, can include a data capture device 116, such as but not limited to mobile phones with cameras, scanners, readers, touch screens, touch pads, and/or digital pens. These customer computer systems 110, which in some embodiments are able to capture future check data from checks drafted before or after the checks are offered as payment, eliminate the need for a separate data capture system 120, such as the digital pen, digital check notebook, etc. Therefore, in some embodiments, the devices and systems described previously in relation to the data capture system 120, can be incorporated into the customer computer systems 110, and will work to capture future check data in the same or similar manner as previously described. For example, the digital pen, in some embodiments, can be incorporated into a PDA or other customer computer system 110, and transmit future check data captured by the digital pen directly to the PDA, other customer computer system 110, or bank computer systems 140.

In some embodiments, the customer computer systems 110 with a data capture device 116, or the data capture system 120 include security feature, such as, a user authentication system that uses passwords or biometric detection. For example, in some embodiments, before a person is allowed to use the data capture system 120 or the data capture device 116, they may be required to enter a password or use a biometric device, such as a thumb or eye scanner, to verify that the person is authorized to make the payment through a check.

In other embodiments, instead of the customer 106 using the data capture system 120 when drafting the check or thereafter, the data capture system 120 can be located on the payee's side of the transaction. For example, after the payee receives payment from the customer 106 the payee uses the data capture system 120, to capture the future check data, as previously described, and communicates with the bank computer systems 140 to share the future check data with the financial institution.

The data capture systems 120, or customer computer systems 110, in some embodiments, are used in conjunction with customer account information so as to provide the customer 106 with more knowledge over the transactions due, paid, and posted to the customer's account. A customer 106 can help manage the customer's accounts using software applications, such as the future checks application 115, to analyze payments due each time period (month, day, year, quarter, etc.), and to interact with customer account applications 145, for coordinating with customers to identify payment schedules. Furthermore, the future checks application 115, can become aware through observation and analysis of scheduled bill payments, or by direct customer 106 input, about when each type of payment is due.

Therefore, in some embodiments, customers 106 are notified when checks still need to be presented for payment, but have yet to be drafted. For example, in some embodiments, the customer 106 creates a schedule list and tracks the list, outlining the checks that the customer 106 needs to write. Comparing this list of checks to future check data from drafted checks, provides an opportunity to notify customers 106 if a payment has been missed prior to the payment being late. For example, a customer 106 could have a bill due on the 15^{th} of the month with a notification set-up to send an alert to the customer if the future check data for that bill has not been received by the 10^{th}. It could be that the bill was delivered to an incorrect address, an e-mail was inadvertently classified as spam/junk mail, mail got mixed in another pile of papers, etc. and the customer 106 forgot to make the payment. Previously, the customer 106 would only be aware of this type of incident when the next bill arrived, illustrating a late fee, further finance charges, and/or loss of promotional terms.

Some embodiments of the future check system 100 are enabled by the ability to capture digital future check data on each check drafted, to determine to whom the check is drafted for, the amount of the check, the customer account, etc. using image processing algorithms. In some embodiments, if the future check data has not arrived in the customer account at the financial institution then the future checks application 115 provides an alert that the customer 106 may have forgotten to pay the bill. In some cases the customer might have paid the bill and forgotten to use the data capture system 120, but in other cases the customer 106 may have forgotten to pay the bill on time.

As future check data is integrated automatically into financial software systems, such as the customer account application 145, in some embodiments, financial institutions are enabled to automatically detect fraudulent checks presented, and to alert customers. Today, check fraud is achieved by intercepting a batch of valid blank checks and forging the customer's signature, printing another customer's account number on a false check, or altering checks that the customer 106 has offered for payment, to name a few examples of check fraud. These situations are more readily detected with the future checks system 100. The financial institution has the future check data from the customer 106, so once a check (paper or image) is presented for payment, the bank is able to cross-reference the check with the future check data sent by the customer 106. If the two do not match up there could be a case of potential fraud. Furthermore, if the signatures don't match up or the check numbers are not in consecutive order for checks presented for payment, again potential fraud could exist. In these cases the bank can send an alert to the customer 106 that potential fraud could exist and the customer 106 and financial institution can respond appropriately.

There are a few secondary benefits that also arise from timely collection of information related to check drafting. In some embodiments, customers 106 are notified when sent checks, have not yet been deposited, as the payment due date arises. For example, in some embodiments the customer 106 could signal the due date on the check, by writing a phrase like “due” next to the due date with a digital pen, by using the date indicated on a future dated check through a camera capture device, by using a known pattern of due dates like when the rent is due every first of the month, etc. Therefore, when the customer 106 drafts the check and sends the future check data to the financial institution, the financial institution now has the necessary information to send back a notification to the customer 106 that the check has yet to be presented for payment by a certain date. This gives the customer 106 notice that the check may have been lost or the payee is not cashing the check for whatever reason. Once the customer 106 is aware the check is missing, the customer has the option to contact the payee as a reminder to cash the check, send another check overnight, pay by phone, use their credit, pay online, or check that late payment is acceptable. In the case where multiple payments are sent to the same entity or person for different reasons, information written on the check like the account number will help to differentiate each payment.

In some embodiments a registration process is used to further provide for customer 106 satisfaction and security. A registration process may be required to associate the digital pen to the customer's account, in part so that any check presented to the bank must have associated future check data drafted with the digital pen (or captured by another device) in order to be sent for settlement and posting. Furthermore, in some embodiments a specific checkbook must be registered with the customer's account, so that any check not received from the registered checkbook is automatically voided. This helps prevent check fraud related to a person stealing a checkbook or individual checks from unregistered checkbooks, or check fraud related to a person changing the account number on false checks presented to the bank. Likewise, an application on a PDA or other mobile device like a phone will involve a registration process for that customer to link up to their financial accounts.

In some embodiments of the invention, the customer 106 will be able to void a check, using the data capture system 120. The customer 106 can void a check or initiate a stop-payment either by using the digital pen directly on the check by writing void on the check, writing void on the check and capturing the image of the check using a camera, using a separate page with a command to apply to the particular check (if the customer 106 no longer has the check in the customer's possession), and/or by informing the bank of the voided check using the future check application 115 if the bank already has the future check data.

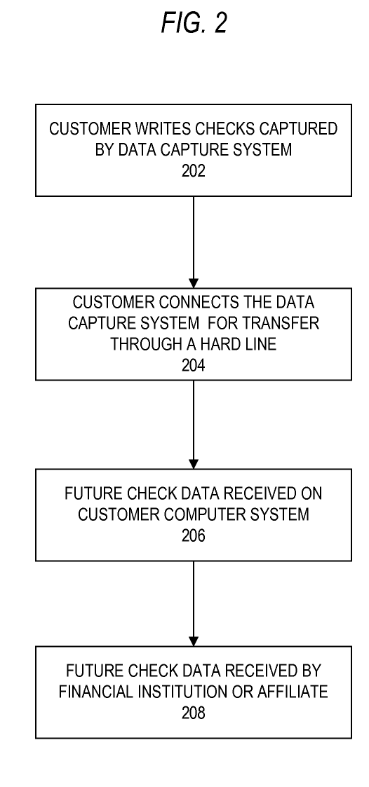

The process of capturing future checks is explained further in FIGS. 2 though 6. These Figures outline how data is captured from customer 106 checks and transactions, and how that data is transferred and used by the customer and financial institutions.

FIG. 2 illustrates a process flow for future check data stored via a customer computer system 110, such as a personal computing device intermediary, including but not limited to a laptop or PDA. As illustrated by block 202 the customer 106 writes his/her check, and captures the future check data with the data capture system 120, such as digital pen. As illustrated by block 204, the future check data is transferred to the customer computer systems 110, such as the customer's laptop, through the use of a hard line connection between the digital pen and the customer's laptop. As illustrated by block 206, the future check data is received by the customer's laptop. As previously discussed the hard line connection between the data capture system 120 and the customer computer systems 110 may be accomplished through the communication device 121 of the data capture system 120 and the communication device 111 of the customer computer systems 110. Thereafter, as illustrated by block 208, the future check data for the customer's account is then transferred over the network 102 to the bank computer systems 140 of the financial institution or an affiliate. In other embodiments the future check data may be initially captured by a camera in a mobile device, included in the customer computer systems 110, and transferred through a hard line connection with the customer's laptop, also included in the customer computer systems 110.

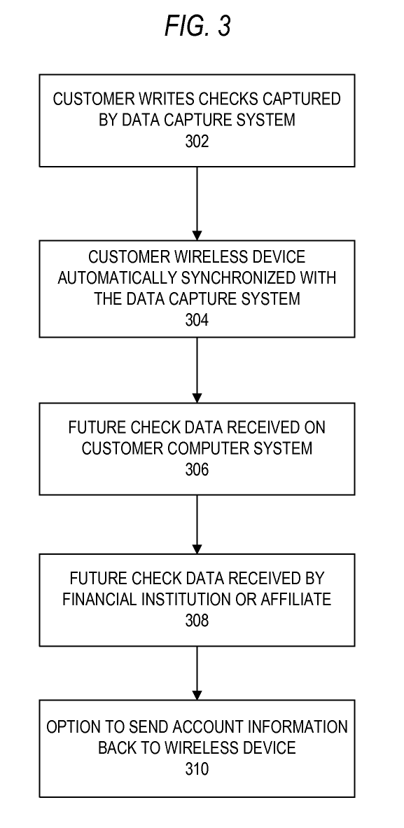

FIG. 3 illustrates another embodiment of a process flow for check data sent to a financial institution or its affiliate using wireless technology. As illustrated by block 302, the customer 106 writes his/her check, and captures the future check data with the data capture system 120, such as the digital pen. As illustrated by block 304, the data capture system 120, has a communication device 121 that is wireless and is synchronized with a wireless communication device 111 in the customer computer systems 110, such as a laptop or PDA. As illustrated by block 306, the future check data is received by the customer's PDA. Thereafter, as illustrated by block 308, the PDA transfers the future check data for the customer's account to the financial institution or an affiliate through the network 102. As illustrated by block 310, account information from the bank computer systems 140 may be transferred back to the customer computer systems 110, after the future check data is taken into account by the customer account application 145. The account information transferred back to the customer 106, includes but is not limited to, information that the customer 106 does not currently have the funds to make the payment, the customer 106 has the required funds currently, but there is another outstanding check scheduled for payment that would not provide enough funds, or any other pertinent information related to the customer's account. In other embodiments, the future check data can be initially captured by a mobile device camera included in the customer computer systems 110 and transferred wirelessly through communication devices to the customer's PDA, laptop, the bank computer systems 140, etc. Still in other embodiments the data capture system 120 can transfer the future check data directly to the bank computer systems 140, circumventing the customer computer systems 110.

In the process flows of FIGS. 2 and 3, the future check data is being shared with the financial institutions to enable the financial institutions to have additional information to improve customer 106 satisfaction and also prevent fraudulent activity. It is possible, however, to implement a subset of the customer account functionality, within the customer computer systems 110. For example, the future checks application 115, in some embodiments updates the customer 106 account information with the future check data using the customer account application 145 in the bank computer systems 140. Alternatively, the customer computer systems 110, or another third party, can periodically receive updates from the financial institutions, through the customer account applications 145 of the bank computer systems 140, related to the account transactions of the customer 106. In this embodiment, the future check data captured by the data capture system 120 or the customer computer systems 110 is never sent to the bank computer systems 140. Software, such as the future check application 115 contained on the customer computer systems 110, is responsible for comparing the future check data with the customer's account. Therefore, the future checks system 100 can be implemented without the need for the financial institutions to modify their backend systems to accept the future check data from the customer 106.

Still in other embodiments of the invention customers 106 having relationships with several financial institutions can have a primary financial institution or third party aggregate collect the future check data and account information from all the customers' financial institutions (themselves or with assistance from a third party), and compare the future checks data with the account information that has been received. The advantage here is the analysis can be performed, even when the customers' devices are dormant. The second advantage here is that alerts can still be triggered on a more limited basis for financial institutions having only transactional data available and no image data. A third advantage is that analysis can be performed on checks for financial institutions having both image and transaction data available, but currently no future checks comparison processing capabilities on checks presented to the financial institution themselves. Finally, both a primary financial institution and third party aggregator can share findings that they discovered when comparing future checks data to presented checks. As financial institutions with checking accounts add more awareness of future checks, this can be done on an incremental basis or all at once. The aggregator can share more or less information with the financial institution such as transactional data (amount of check, check dates, etc.) and/or the check images.

In some embodiments the software used in the future checks system 100 for the data capture system 120 and customer computer systems 110, including but not limited to the data capture application 125 and future checks application 115, is downloaded from the bank, in order to work in conjunction with the customer account application 145 and other applications. Alternatively, in some embodiments, a third party provides the software for the future checks system 100, which is compatible with the software in the customer computer systems 110, data capture server 130, and bank computer systems 140. The software downloaded, in some embodiments, allows the customer 106 to use the data capture system 120 and/or customer computer systems 110 to capture future check data, and/or interface with the customer's account, in order to compare the future check data with the customer's account information.

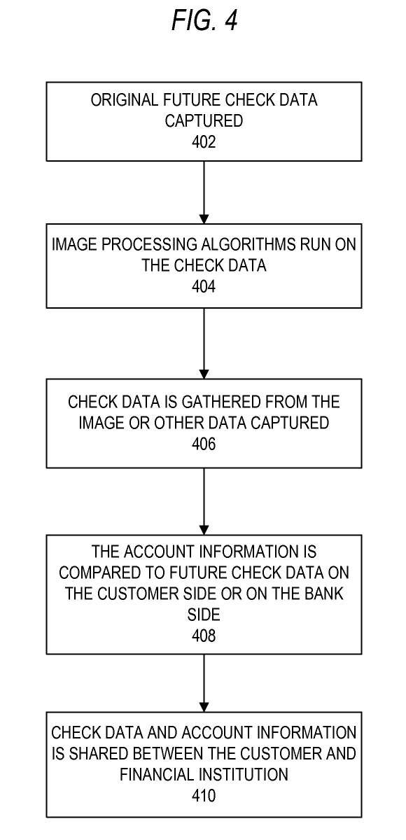

FIG. 4 illustrates the process of how the pending check data can be analyzed either before and/or after it is sent to the financial institution. As illustrated by block 402, the future check data is captured using the data capture system 120 (e.g. digital pen) or the customer computer systems 110 (e.g. mobile device with a camera). Thereafter, as illustrated by block 404, either before the future check data is sent to the bank computer systems 140 or after the future check data is sent to the bank computer systems 140, algorithms are applied to interpret the future check data. As illustrated by block 406, these algorithms can extract information like the date entered, the draftee, the payee, notes written on the check, the customer signatures, check number, account number, routing/transit number, etc. from any check picture/image or captured data. As illustrated by block 408, either the future check data can be compared against the customer's account information on the customer's side, or through the financial institution (i.e. bank, third party, or affiliate). Furthermore, as illustrated by block 410, all or portions of the future check data and customer account data can be shared between the customer computer systems 110 and the bank computer systems 140, so all parties will have the same understanding of the customer's account information, future check data, and other transactions.

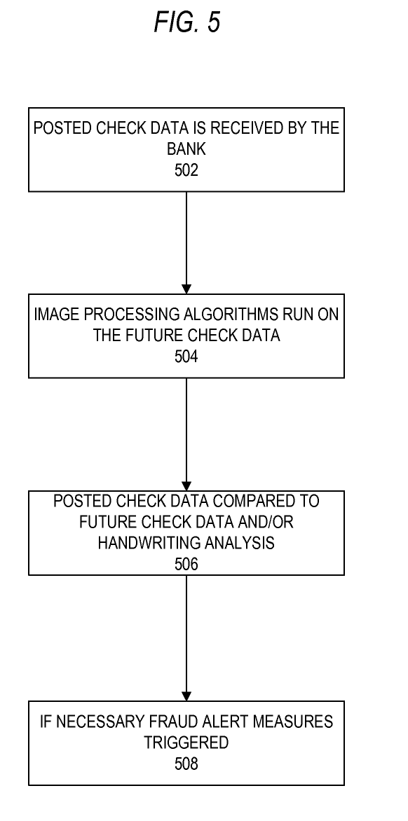

FIG. 5 illustrates a process outlining how the future check data is compared to pending check data for fraud purposes. As illustrated by block 502, posted checks and associated data is received by the bank. As illustrated by block 504 image or data processing algorithms will interpret the check data, including in some cases but not limited to, a handwriting analysis of the signature of the check drafter. As illustrated by block 506, the posted check data is compared to the future check data and/or the handwriting analysis to determine any potential differences between the posted check data and the future check data, such as differences in the check amounts, any differences in the handwriting of the signatures, etc. As illustrated by block 508, if necessary, fraud alert measures are triggered when discrepancies are identified between the posted check data and the future check data. The messages are sent to the customer 106, in some embodiments, for the customer's 106 immediate attention. The customer 106 can either verify or deny that the check is a check the customer 106 drafted. In other embodiments of the invention the future check data need not be sent to the bank computer systems 140. As previously discussed the future checks application 115, may receive periodic updates from the bank computer systems 140 regarding check data from checks presented to the bank for payment. Thereafter, the future checks application 115, on the customer computer systems 110, can make the determination if there any differences between the future checks data and any posted checks delivered to the bank.

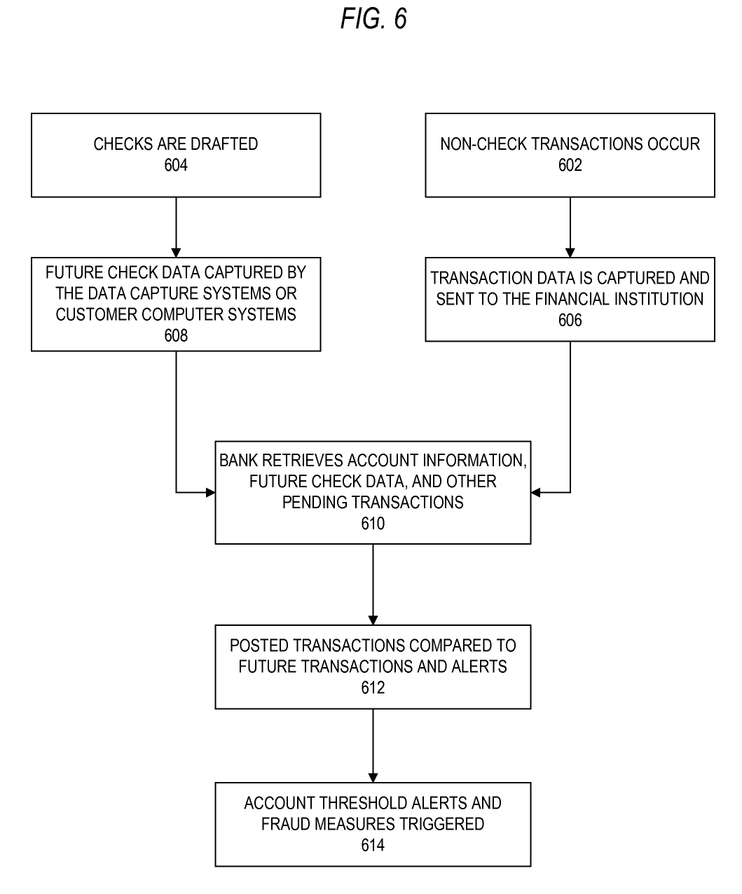

FIG. 6, is a process outlining when non-check transactions or drafted check transactions affect a customer's account in such a way that notifications are sent to the customer 106 regarding the scheduled transactions or non-scheduled transactions. As illustrated by blocks 602 and 604 either non-check transactions occur or checks are drafted. As illustrated by block 606, when non-check transactions occur, such as check card withdrawals or payments, automatic transfers, scheduled payments, etc. the transaction data is captured and sent to the proper financial institution (or a third party or affiliate). As illustrated by block 608, when checks are drafted, the future check data is captured by the data capture system 120, or customer computer systems 110, including but not limited to when the check is due. As an illustration, some checks may be future dated, others may signal the due date by another means like writing “due date” followed by the date, and others are recurring payments where an alert or trigger has been setup based upon the typical due date, like due on the 1^{st} of the month for rent checks. Furthermore, check information can be recorded in the customer account application 145 that certain payments are due at certain times.

As illustrated by block 610, either before or after the check or non-check transaction data is captured, the customer computer systems 110 or bank computer systems 140 will retrieve account information, future check data, and other pending transactions related to the customer's account.

As illustrated by block 612 any posted transactions are compared to future check data and any alerts set up by the customer 106 or indentified by the customer account application 145. Alerts include, but are not limited to payments past the due date or submit date (date the customer 106 has selected as the alert notification date) for which the customer 106 has not drafted a check, drafted checks that have not been presented to the bank for which there is future check data, checks received for which there is no future check data, any differences that occur between checks received and future check data, etc. As illustrated by block 614, any account threshold alerts and measures that have been triggered are sent to the customer 106 through the customer computer systems 110.

For example, based upon due date information included in the future check data captured, the future check system 100 can alert the customer 106 that the check drafted by the customer 106 has yet to be presented or posted to the account. A customer 106 can then investigate as to the reasons the check did not post. The customer 106 may find that he/she forgot to send the check in for payment, or the check could have been lost in the mail, or lost by the entity or person that the customer 106 submitted the check to for payment. The customer 106 then has the option to write out a new check and cancel the old, send a payment electronically, make a payment using a pay-by-phone technique, or negotiate sending another check at a later time. In some embodiments the future check system 100 can identify that the customer 106 made the payment by another means besides a check, thus skipping the alert from being triggered in these cases.

As another example, the future check system 100 can have alerts setup to detect when checks have yet to be drafted for payments due. Since past drafted checks are known, it is possible to detect that a check that usually should have been drafted has not yet been drafted. For example, the customer may forget to write a rent check on the 1^{st} of the month that is due on the 5^{th} of the month. An alert on the 2^{nd} of the month is triggered to remind the customer to draft the check. Once the check is drafted, the alert will no longer trigger for that month. The system may optionally detect the payment was made via another means, like credit card, automated clearing house (“ACH”), or debit card. While the severity for missing a payment is sometimes only late fees, finance charges, and loss of promotional terms, missing some payments like rent may be cause for eviction, making detection of these instances of high importance.

This invention solves a number of the issues identified with check processing and account management. It provides a process for the early capture of checks written with minimal customer hassle, even with multiple persons on the same account. Furthermore, it includes the ability to alert account holders on the impacts to checks recently drafted, but not yet deposited, without having to manually enter the check information. The process provides the ability to detect fraudulent checks more rapidly, regardless of whether blank stolen customer checks were used or new checks were used with the customers' account information. Furthermore, it provides the customers 106, as well as financial institutions, the ability to detect changes in the amount and conditions on authorized customer 106 checks by people and entities that have handled the check after the customer 106 has presented the check for payment.

This future checks system 100 also allows for the integration and retention of digital check images right away into customers' financial software on the customer computer systems 110 or remotely with a third-party provider, rather than just as images stored with the financial institutions. Furthermore, the future checks system 100 allows for additional handwriting analysis, not just on what is written, but how the words are written on the check. This can also detect potential fraud even when a person who is not the customer 106 uses the customers' 106 data capture system 120 in drafting the check. Additionally, customers 106 periodically miss sending in a payment, which sometimes results in late fees and other undesirable impacts. Customers 106 only learn about a late payment, after it is already processed as late. This future checks system 100 helps mitigate the risk of missing payments. Besides individual banking customers wishing to reduce fraud and better manage their financial account, businesses can use these tools to reduce fraud and to further ensure only those that are authorized can issue checks.

Specific embodiments of the invention are described herein. Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

What is claimed is:

1. A future check integration system comprising:
a data capture device;
a memory device;
a communication device; and
a processing device operatively coupled to the data capture device, the memory device, and the communication device, wherein the processing device is configured to execute computer-readable program code to:
capture data related to a check, before the check is presented to a paying bank, using the data capture device;
store the captured data related to the check on the memory device; and
receive account information from a financial institution or affiliate, using the communication device that is configured to communicate with a device at the financial institution or affiliate.

2. The future check integration system of claim 1, wherein the data capture device comprises a digital pen configured to capture information written on the check.

3. The future check integration system of claim 1, wherein the data capture device comprises a digital device with a camera for capturing an image of the check.

4. The future check integration system of claim 1, wherein the data capture device comprises a device with a touch screen or touch pad configured to capture information written on the check.

5. The future check integration system of claim 1, wherein the data capture device comprises a reader configured to capture machine-readable information located on the check.

6. The future check integration system of claim 1, wherein the processing device is configured to execute computer-readable program code to communicate the captured data related to the check to the financial institution or affiliate, using the communication device that is configured to communicate with a device at the financial institution or affiliate, wherein the financial institution or affiliate compares the captured data related to the check with a customer's account information.

7. The future check integration system of claim 1, wherein the processing device is configured to execute computer-readable program code to receive account information from the financial institution or affiliate, using the communication device that is configured to communicate with a device at the financial institution or affiliate, wherein the account information comprises, at least partially, a comparison of the captured data related to the check with a customer's account transactions.

8. The future check integration system of claim 1, wherein the processing device is configured to execute computer-readable program code to receive account information from the financial institution or affiliate, using the communication device that is configured to communicate with a device at the financial institution or affiliate, wherein the account information comprises, at least partially, alerts related to the check, such as the check is within the available funds, an overdraft will occur, or an overdraft might occur.

9. The future check integration system of claim 1, wherein the processing device is configured to execute computer-readable program code to receive account information from the financial institution or affiliate, using the communication device that is configured to communicate with a device at the financial institution or affiliate, wherein the account information comprises, at least partially, alerts related to the check that potential fraud has occurred with a customer's account.

10. A future check integration system comprising:
a data capture device;
a memory device;
a communication device; and
a processing device operatively coupled to the data capture device, the memory device, and the communication device, wherein the processing device is configured to execute computer-readable program code to:
capture data related to a check, before the check is presented to a paying bank, using the data capture device;
store the captured data related to the check on the memory device; and
communicate the captured data related to the check to at least one other device, using the communication device that is configured to communicate with the at least one other device.

11. The future check integration system of claim 10, wherein the at least one other device comprises a device in a customer computer system that is configured to receive the captured data related to the check, and wherein the customer computer system is configured to receive account information from a financial institution or affiliate, and to compare the captured data related to the check to the account information.

12. The future check integration system of claim 10, wherein the at least one other device comprises a device in a bank computer system that is configured to receive the captured data related to the check, and wherein the bank computer system is configured to compare the captured data related to the check to account information.

13. The future check integration system of claim 10, wherein the processing device is configured to execute computer readable-program code to receive account information from a financial institution or affiliate, using the communication device that is configured to communicate with a device at the financial institution or affiliate, wherein the account information comprises, at least partially, a comparison of the captured data related to the check with a customer's account transactions or, at least partially, alerts related to the check, such as the check is within the available funds, an overdraft will occur, an overdraft might occur, or potential fraud has occurred with a customer's account.

14. The future check integration system of claim 10, wherein the data capture device comprises a digital pen configured to capture information written on the check.

15. The future check integration system of claim 10, wherein the data capture device comprises a digital device with a camera for capturing an image of the check.

16. The future check integration system of claim 10, wherein the data capture device comprises a device with a touch screen or touch pad configured to capture information written on the check.

17. The future check integration system of claim 10, wherein the data capture device comprises a reader configured to capture machine-readable information located on the check.

18. A future check integration system comprising:
a memory device;
a communication device; and
a processing device operatively coupled to the data capture device, the memory device, and the communication device, wherein the processing device is configured to execute computer-readable program code to:
receive data related to a check, before the check is presented to a paying bank, using the communication device that is configured to communicate with a device in a customer computer system or a data capture system;
store the captured data related to the check on the memory device; and
compare the captured data related to the check with a customer's account information.

19. The future check integration system of claim 18, wherein the processing device is configured to execute computer-readable program code to communicate an application to a data capture system or a customer computer system, wherein the application provides the user with the capability of capturing check data or receiving account information.

20. The future check integration system of claim 18, wherein the processing device is configured to execute computer-readable program code to communicate alerts related to the check to the customer computer system, such as the check is within the available funds, an overdraft will occur, or an overdraft might occur.

21. The future check integration system of claim 18, wherein the processing device is configured to execute computer-readable program code to communicate alerts related to the check to the customer computer system that potential fraud has occurred with a customer's account.

22. The future check integration system of claim 18, wherein the processing device is configured to execute computer-readable program code to receive actions from the customer computer system to transfer funds, stop payment on the check, change a date of payment for the check, or change alerts set up by a customer.

23. A computer program product for a future check integration system, the computer program product comprising at least one computer-readable medium having computer-readable program code portions embodied therein, the computer-readable program code portions comprising:
an executable portion configured for capturing data related to a check, before the check is presented to a paying bank, using a data capture device and a processing device, wherein the processing device is operatively coupled to the data capture device, a memory device, and a communication device, and is configured to execute computer-readable program code;
an executable portion configured for storing the captured data related to the check on a memory device; and
an executable portion configured for communicating the data related to the check to at least one other device using the communication device that is configured to communicate with the at least one other device.

24. The computer program product of claim 23, wherein the data capture device comprises at least one of a digital pen configured to capture information written on the check, a digital device with a camera configured to capture an image of the check, a device with a touch screen or touch pad configured to capture information written on the check, or a reader configured to capture machine-readable information located on the check.

25. The computer program product of claim 23, wherein the at least one other device comprises a device in a customer computer system that is configured to receive the captured data related to the check, and wherein the customer computer system is configured to receive account information from a financial institution or affiliate, and to compare the captured data related to the check to the account information.

26. The computer program product of claim 23, wherein the at least one other device comprises a device in a bank computer system that is configured for comparing the captured data related to the check with account information from a financial institution or affiliate.

27. The computer program product of claim 23, further comprising an executable portion configured to receive account information from a financial institution or affiliate using the communication device that is configured to communicate with a device at a financial institution or affiliate, wherein the account information comprises, at least partially, a comparison of the captured data related to the check with a customer's account transactions or, at least partially, alerts related to the check is within the funds in the account, will cause an overdraft in the account, could cause an overdraft in the account, or potential fraud has occurred with the customer's account.

28. A computer program product for a future check integration system, the computer program product comprising at least one computer-readable medium having computer-readable program code portions embodied therein, the computer-readable program code portions comprising:
an executable portion configured for receiving from a customer computer system or a data capture system data related to a check, before the check is presented to a paying bank, using a communication device and a processing device that is operatively coupled to the communication device and a memory device, and configured to execute computer-readable program code;
an executable portion configured for storing the captured data related to the check on the memory device; and
an executable portion configured for comparing the captured data related to the check with a customer's account information.

29. The computer program product of claim 28, further comprising:
an executable portion configured for communicating an application to the data capture system or the customer computer system, using a communication device configured to communicate with the customer computer system or the data capture system, wherein the application provides the user with the capability of capturing the data related to the check or receiving the customer's account information.

30. The computer program product of claim 28, further comprising:
an executable portion configured for communicating alerts related to the check to the customer computer system or the data capture system, such as the check is within the available funds, an overdraft will occur, or an overdraft might occur, using a communication device configured to communicate with the customer computer system or the data capture system.

31. The computer program product of claim 28, further comprising:
an executable portion configured for communicating alerts related to the check to the customer computer system or the data capture system that potential fraud has occurred with a customer's account, using a communication device configured to communicate with the customer computer system or the data capture system.

32. The computer program product of claim 28, further comprising:
an executable portion configured for receiving account actions from the customer computer system or the data capture system to transfer funds, stop payment on the check, change the date of payment for the check, or change the alerts set up by a customer, using a communication device configured to communicate with the customer computer system or data capture system.

33. A future check integration method, comprising:
capturing data related to a check, before the check is presented to a paying bank, using a data capture device and a processing device operatively coupled to the data capture device, a memory device, and a communication device, and configured to execute computer-readable program code;
storing the captured data related to the check on the memory device; and
communicating data related to the check using a communication device configured to communicate with at least one other device.

34. The future check integration method of claim 33, wherein the data capture device comprises at least one of a digital pen configured to capture information written on the check, a digital device with a camera configured to capture an image of the check, a device with a touch screen or touch pad configured to capture information written on the check, or a reader configured to capture machine-readable information located on the check.

35. The future check integration method of claim 33, wherein the at least one other device comprises a device in a customer computer system that is configured for receiving the captured data related to the check, and wherein the customer computer system is configured to receive account information from a financial institution or affiliate, and to compare the captured data related to the check to the account information.

36. The future check integration method of claim 33, wherein the at least one other device is a device in a bank computer system that is configured for comparing the captured data related to the check with account information from a financial institution or affiliate.

37. The future check integration method of claim 33, wherein the processing device is configured to execute computer readable-program code for receiving a customer's account information from a financial institution or affiliate to compare the data related to the check to a customer's account information, using a communication device configured to communicate with the financial institution or affiliate.

38. The future check integration method of claim 33, wherein the processing device is configured to execute computer readable-program code for receiving account information from a financial institution or affiliate, using the communication device that is configured to communicate with a device at the financial institution or affiliate, wherein the account information comprises at least partially a comparison of the captured data related to the check with a customer's account transactions or at least partially alerts related to the check, such as the check is within the available funds, an overdraft will occur, an overdraft might occur, or potential fraud has occurred with a customer's account.

39. A future check integration method, comprising:
receiving from a customer computer system or data capture system data related to a check, before the check is presented to a paying bank, using a communication device and a processing device that is operatively coupled to the communication device and a memory device, and configured to execute computer-readable program code;
storing the captured data related to the check on the memory device; and
comparing the captured data related to the check with a customer's account information.

40. The future check integration method of claim 39, comprising:
communicating an application to the data capture system or the customer computer system, using a communication device configured to communicate with the customer computer system or the data capture system, wherein the application provides the user with the capability of capturing the data related to the check or receiving the customer's account information.

41. The future check integration method of claim 39, comprising:
communicating alerts related to the check to the customer computer system or the data capture system, such as the check is within the available funds, an overdraft will occur, or an overdraft might occur, using a communication device configured to communicate with the customer computer system or the data capture system.

42. The future check integration method of claim 39, comprising:
communicating alerts related to the check to the customer computer system or the data capture systems, such as potential fraud has occurred with a customer's account, using a communication device configured to communicate with the customer computer system or the data capture system.

43. The future check integration method of claim 39, comprising:
receiving account actions from the customer computer system or the data capture system to transfer funds, stop payment on the check, change the date of payment for the check, or change alerts set up by a customer.
